(19) United States
(12) Patent Application Publication
(10) Pub. No.: US 2015/0242584 A1
(43) Pub. Date: Aug. 27, 2015

(54) Method for Providing Remote Professional Services

(71) Applicant: Charles F. Butler, Dallas, TX (US)

(72) Inventor: Charles F. Butler, Dallas, TX (US)

(21) Appl. No.: 14/605,975

(22) Filed: Jan. 26, 2015

Related U.S. Application Data
(60) Provisional application No. 61/931,700, filed on Jan. 27, 2014.

(51) Int. Cl. G06F 19/00

(52) U.S. Cl. CPC G06F 19/3418; G06F 19/328; G06F 19/3425

(57) ABSTRACT

A device that allows professional service providers and patients/clients to communicate via video and telecommunications, while also allowing the service providers to bill for their time. The device can be a standalone device that is designed specifically for this purpose or a program that either the patient/client, the provider, or both, can download to either a smartphone, tablet, or computer. Among other things, the device can allow a patient/client to select from a group of service providers by filtering via various categories. Professional service providers will be able to bill the patient/client for his time via the device. In some instances the service provider will bill by a given time period, in other instances that service provider will charge a flat fee. In some embodiments the service provider will have the ability to adjust a predetermined fee after servicing the patient.

### CROSS-REFERENCE TO RELATED APPLICATIONS

This application is related to and claims priority from U.S. Provisional Application Ser. No. 61/931,700 having a filing date of Jan. 27, 2014, entitled “Method for Providing Remote Professional Services”. The '700 application is hereby incorporated by reference herein in its entirety.

### FIELD OF THE INVENTION

The present invention relates to the use of telecommunication technology, including: video and voice calls, text chat, photo sharing, smart phones, tablets, the internet, and computers to provide access to professional service providers to those seeking professional services but located remotely. The invention also relates to a novel way of billing clients for time spent administering care. One embodiment of the invention involves using a smartphone application to both connect patients with doctors, and provide a tool that can be used both to assist with diagnosis as well as transferring payment from patient to doctor.

### BACKGROUND OF THE INVENTION

It is no secret that medicine has become increasingly specialized, as well as increasingly expensive. The passage of the Affordable Care Act shows just how prominent the issue of rising medical costs has become to the American public. Any way to decrease medical costs and make the process more efficient would be useful.

One of the problems with current medical practices is that patients must usually make an appointment to see the doctor. This is true even if the patient only needs to ask a doctor a quick question. Thus, instead of taking up only five minutes of both the patient's and doctor's time, the patient is forced to spend both the time and high monetary cost associated with making an official office visit. The doctor meanwhile is prevented from helping more patients, because he had to block out the entire time slot for the patient.

Another problem with current medical practices is that while specialization has advanced medical care, it requires patients seeking this advanced care to live in or travel to areas that can support these specialized doctors. Many individuals live in rural area that contain few or no medical specialists. These individuals often have to travel hundreds of miles to receive the care they need or, in many instances, simply go without it. While many doctors would like to reach these patients, both for humanitarian as well as financial reasons, until recently it simply was not feasible. However, with increases in technology, specifically video telecommunications, doctors can now diagnose clients from a remote location.

What is needed is a convenient way for doctors to offer and bill for remote services and a convenient way for patients to receive care that does not warrant a full office visit.

### SUMMARY OF THE INVENTION

The present application describes a device that allows professional service providers and clients/patients to communicate via video and telecommunications, while also allowing the service providers to bill for their time. Professional service providers includes among others: doctors, lawyers, consultants, physical trainers, dating services, and even adult entertainers.

The device can be a standalone device that is designed specifically for this purpose or a program that either the client/patient, the professional service provider, or both, can download to either a smartphone, tablet, or computer. The device, can be two programs, one that professional service providers download and one that potential patient/clients download, that interact with each other. In other instances, a single program can be used, with certain features accessible to only professional service providers, and certain features accessible to only patients/clients.

The user can interact with the device through conventional ways such as keyboard, mouse, or touchscreen or through more emerging ways such as hand motions and voice control.

Among other things, the device can allow a patient/client to select from a group of professional service providers by filtering via various categories. For example, if the special service provider is a doctor, the categories can include: the doctor's specialty; symptoms; the doctor's physical location; the doctor's current availability; and/or the medical school the doctor attended.

Professional service providers will be able to bill the patient/client for his time via the device. In some instances the professional service provider will bill by a given time period, such as x dollars (or credits) per minute. In other instances that professional service provider will charge a flat fee. In some embodiments the professional service provider will have the ability to adjust a predetermined fee after servicing the patient/client. For example, the device may automatically charge a patient/client $10.00 per minute for the duration of the call. In some instances, the service provider may want to decrease this charge at the conclusion of the meeting. A service provider may wish to do this if part of the call was not spent providing services. In other instances the patient/client and service provider may have agreed that a full office visit is warranted, and the service provider agrees to write off part or all of the time spent talking to the patient/client over the phone. Regardless of the reason, in some embodiments the current device will grant the professional service provider the ability to change the amount billed.

### BRIEF DESCRIPTION OF THE DRAWINGS

FIG. 1 is a schematic view of the patient portion of the application.

FIG. 2 is a schematic view of the doctor portion of the application.

### DETAILED DESCRIPTION OF PREFERRED EMBODIMENT(S)

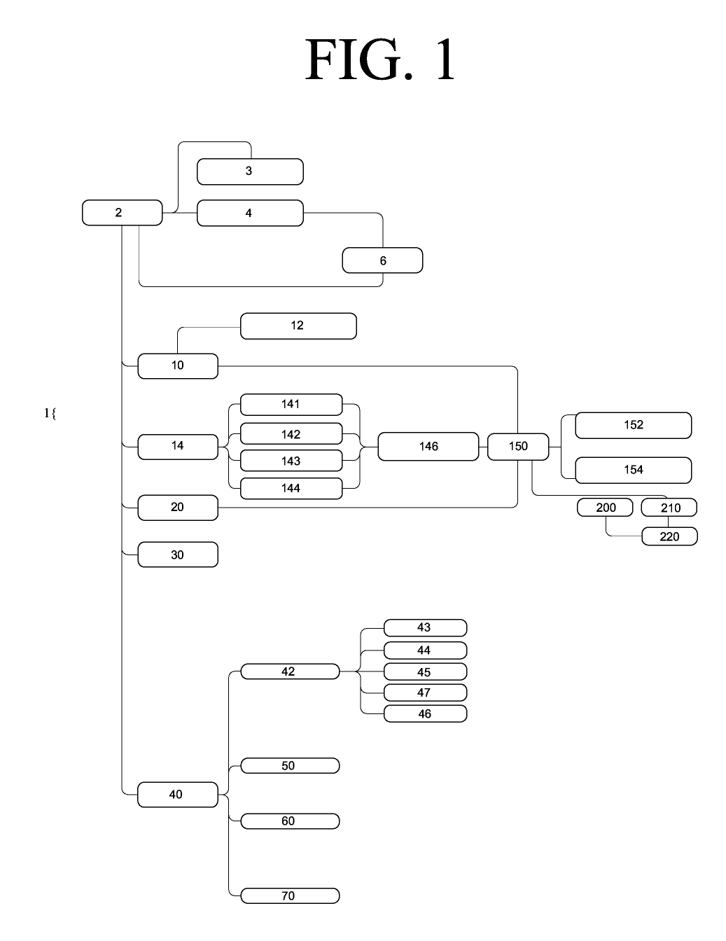

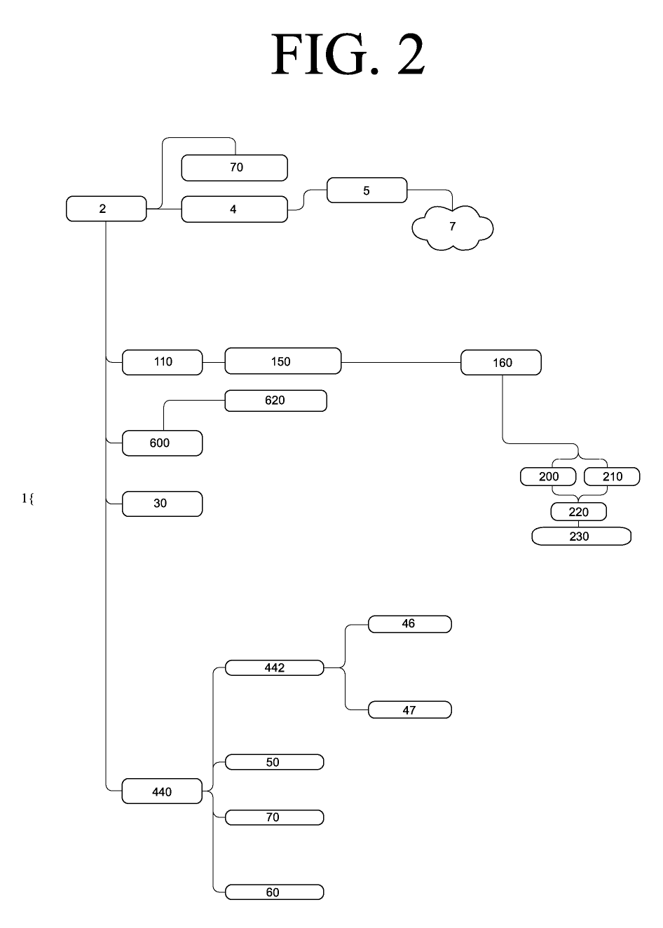

FIG. 1 and FIG. 2 represent schematics of different parts of Application 1. In some embodiments FIG. 1 and FIG. 2 can represent separate applications.

Upon starting Application 1, the user, either a doctor or a patient is taken to Login Screen 2. If the user has already registered, he can sign into Application 1 by typing in the email address and password used to register. If this is the user's first time using Application, he will have to proceed to Registration Screen 4 which is accessible from Login Screen 2.

At Registration Screen 4 the user will have to indicate if he is a doctor or a patient. If user chooses patient, he will be taken to Patient Registration Screen 6. At Patient Registration Screen 6, the user will be prompted to enter his email address, his gender, his birthdate, a username and a password. In some embodiments the user must enter the password twice and/or view and agree to a User Agreement and Privacy Policy before he can register. In at least one embodiment, Application 1 will refuse to register a user who indicates that he is under eighteen years old.

If the user indicates that he is a doctor on Registration Screen 4, he will be taken to Doctor Registration Screen 5 which directs user to Doctor Registration Website 7. See FIG. 2. This provides a more robust registration for doctors, who should have their credentials verified.

A user can also open Password Retrieval Screen 3 from Login Screen 2 if he forgot his password. From Password Retrieval Screen 3, the user can have his password emailed to the email address affiliated with the account.

If the patient has registered before and correctly enters his email address and password on Login Screen 2, he is taken to Patient Schedule 10. The first time the user enters Patient Schedule 10, he will likely not have scheduled any appointments, and will be prompted to search for a doctor. If the patient does have appointments he can see them in Patient Schedule 10, which can be viewed as a list or as a calendar.

When viewing Patient Schedule 10 in list mode most, if not all, appointments are put in a list that can be sorted using various criteria, including date and doctor. The color code of green, yellow and red are used to indicate confirmed, pending and rejected appointments, respectfully. In some embodiments, pending appointments can be canceled without a cost to the patient as the doctor has not accepted the appointment, while canceling confirmed appointments will incur a fee. In other embodiments, confirmed appointments can be canceled up to, and even past, the appointment time without incurring a fee.

The user can decide to view Patient Schedule 10 in month view where he can see his active calendar appointments for the current day or month, or even part of future months on a screen. When viewing Patient Schedule 10 in month view, dates with rejected appointments have a red background, confirmed appointments have a green background, and pending appointments have a yellow background.

A user can also choose to view his appointments in Patient Overview Screen 12 which is also accessible from Patient Schedule 10. Here appointments can be viewed in three categories, “Confirmed,” “Pending,” and “All”. Patient Overview Screen 12 can also contain a graphic indicating the total amount of credits the user has in his account.

The user can access Doctor Search 14, Favorites 20, History Screen 30, Patient Settings Screen 40, or Patient Schedule 10 via a toolbar that is present on many of the main screens of the patient part of Application 1.

From Patient Settings Screen 40 the patient can do a myriad of things including: “Logout” to close the current session; open Patient Profile Screen 42 to edit personal information; open Feedback Screen 50 that allows the patient to provide the program operator and/or developers with information about a problem with application, praise application, or suggest an improvement for application; open Sync Screen 60 which allows the patient to configure program to sync (either automatically or on command) with various schedules such as iCal, Google Calendar or Outlook; and open Share Screen 70 that allows the patient to share use of the application on social networks such as Facebook, Twitter and LinkedIn as well as with their email contacts.

From Patient Profile Screen 42 the patient can perform a variety of functions. For starters, he can turn anonymous mode “On” or “Off”. In one embodiment, when anonymous mode is turned “On,” personal information such as medical history and the patient's name is kept private from the doctor. Instead, the doctor can only see the patient's age and sex. On Patient Profile Screen 42, the patient can also add personal attributes not asked during registration and/or also edit many factors that may have been incorrectly entered during registration or have changed. For example the patient can change his real name, change his gender, add a photo to his profile, add his weight, change his birthdate, and add his current address and emergency contacts.

Medical Records 43 are also accessible from Profile Screen 42. In Medical Records, the patient can update his medical records, including such factors such as health problems, allergies, medications, test results and lifestyle factors.

From Patient Profile Screen 42 the patient can also: open Insurance Screen 44 and update his insurance information; view his remaining credits and open Purchase Credits Screen 45 to add credits to his balance. The User Agreement Screen 46 and Privacy Policy Screen 47 are also accessible from Patient Profile Screen 42 and the patient can also change his password.

Doctor Search 14 can be brought up via the search icon located on the menu bar. It allows the user to search via: keywords that can be typed in a search box; location; insurance accepted; symptoms, and/or specialties.

Searching via location will bring up Location Search 141 in which the user can chose to search via city and state, zip code, or within a radius of their actual location which can be determined using GPS equipment located on the device running Application. The user can return to Doctor Search 14 via the done icon.

Searching via specialties brings up Specialties Search 142. Here the user can type the specialty/specialties sought and/or pick them from a menu. He can return to Doctor Search 14 via the done icon.

Searching via insurance will bring up Insurance Search 143. Here the patient can select his insurance, either by typing it into a box and/or selecting it from a menu. The user can return to Doctor Search 14 via the done icon.

Searching via symptoms with bring up Symptom Search 144. Here the patient can select the symptom(s) he is feeling. Again these can be typed into a box and/or selected from a menu. The user can return to Doctor Search 14 via the done icon.

In some embodiments, as the user is narrowing his selection via the various search options, a field on Doctor Search 14 will display the number of doctors in the system that currently meet the indicated criteria.

After the user has selected each of the factors from which he wants to search, he can see his results on Results Page 146 by clicking/touching the “Show Results” icon on Doctor Search 14. The results on Result Page 146 maybe filtered by, among other things: a keyword typed into a search box; the physical location of the doctor's office; the rating of the doctor, where ratings can be based on user ratings and/or ratings from other companies/services; and the cost the doctor charges per minute.

In many parts of Application 1, including Results Page 146, and Schedule 10 the user can tap the doctor's name and/or picture to bring up Doctor Card 150 for that doctor. Each doctor in the system will have a custom doctor card. Included on Doctor Card 150 will be various information about the doctor which can include but is not limited to the doctor's name, location, rating (along with comments left by previous patients), professional biography and board certification, the insurance the doctor accepts, and the doctor's cost per minute. Some of this information can require opening a new screen.

If the user had the doctor before, he will also be able to rank the doctor and leave comments. In some embodiments the user will also be able to add the doctor to his favorites and/or schedule an appointment. In at least one embodiment, the user has the option to instantly video call or voice call the doctor immediately from Doctor Card 150 without even making an appointment if the doctor is online. In some embodiments, if the doctor is offline, the user can click notify when available and the user will be notified when the doctor comes online. Some or all of these aspects of Application 1 can require opening a new screen.

In some embodiments, the user can request an appointment with a particular doctor directly via Results Page 146 or via Doctor Card 150. Clicking the relevant icon will bring up Appointment Request Screen 152. Appointment Request Screen 152 shows a monthly calendar with dates with open appointments highlighted in blue. The user can also change the month to find additional openings. The user can then click on the shown dates highlighted in blue. Application 1 will then prompt the user to pick a particular time to schedule the appointment. After selecting the appointment time, in some embodiments Application 1 can allow the user to adjust the length of the appointment and attach a note to the doctor, before sending the request for the appointment.

In at least some embodiments, the user can access Doctor Rating 154 via Doctor Card 150. On Doctor Rating 154 the user can (assuming the user had a previous appointment with the doctor) click on stars to rate the doctor and write a comment about the doctor. The user can also read other reviews (including star ratings) written by other patients about the doctor and/or see the doctor's total star rating. The star rating is obviously a generic rating system, and other rating systems such as a numerical or alphabetic system can be used.

In at least some embodiments the menu contains a “Favorites” icon. Activating the icon brings up Favorites 20. Here, doctors the user has tagged as favorites can be sorted based on, among other things, their names, ratings, locations, cost, and specialties. In some embodiments they can also be sorted by who is currently online.

In at least some embodiments the menu contains a “History” icon. Activating the icon brings up History Screen 30. Here the patient's appointment history including costs, date, time duration, and doctor can be viewed and sorted. This information can also be exported to other file formats so patients can keep a record of their doctors “visits” possibly for insurance purposes. In some embodiments, actual conversations, including text, video, and audio are actually recorded and stored to be accessed via History Screen 30 at a later time. In this way, patients are able to review the doctor's advice at a later date.

When a video call between a doctor and patient is taking place, the application goes to Video Call Screen 200 or Voice Call Screen 210. Along with streaming video, Video Call Screen 200 can also include, among other things, the current balance of the patients credits, a call timer, a button to mute the patient's mic, a button to end the call, a button to send an image to the doctor (useful for taking pictures of injuries, or other symptoms that can help the doctor in his diagnosis.) Finally Video Call Screen 200 can also include the option to open Chat Box 220 which serves to receive text messages and photos that are sent. This is helpful if that patient is deaf, or if the doctor wants to write instructions for the patient to follow at a later time.

Turning to FIG. 2, which represents the doctor based part of Application 1, it is important to note that many of the screens from the patient part of FIG. 1 will be reused. While this does not have to be the case, reusing the parts allows for Application 1 to take up less memory and be streamlined.

The doctor section of Application 1 contains Doctor Schedule 110 on which the doctor is able to open his schedule in either a calendar view or list view and filter appointments by Confirmed, Canceled or Pending. In calendar view, days with grey backgrounds are available to schedule appointments, days with red backgrounds indicate a rejected appointment on that day, while yellow and green backgrounds, indicated pending and confirmed appointments on those days, respectfully. Tapping on the “Today” icon brings the calendar to the current date while tapping on the forward and backward arrows brings up the next and previous months, respectfully.

In list view, appointments with a red mark were either rejected either by the doctor or the patient, appointments with a yellow mark are pending, and appointments with a green mark are confirmed. The doctor can tap the appointments to view relevant details, such as notes from the patient

Doctor Schedule 110 also includes a wallet icon showing the number of credits the doctor currently has earned as well as an “Online” icon which allows the doctor to switch between “Online” and “Offline” modes. In this embodiment, when the doctor is in “Offline” mode he cannot receive calls, and will not appear online to patients.

Clicking on pending appointment will bring up Requested Appointment Screen 150. Here the doctor can view information about the proposed time of the appointment and the patient who requested the appointment. For example the doctor can open Patient Information Screen 160, read notes from the patient, view his rate per minute (or other rate), the duration of the requested appointment. The doctor can also cancel/deny the appointment outright on Requested Appointment Screen 150. Here the doctor might chose to include a note explaining why he will not see the patient. Perhaps, the patient has special circumstances the doctor is not comfortable handling. The doctor can also cancel/deny the requested appointment, and suggest another time.

Patient Information Screen 160 contains information the patient included in Patient Profile Screen 42. For example it can include the name, sex, weight, and age of the patient. It can also include insurance information, a picture of the patient, and the patients' medical records including health problems, allergies, medication, test results, and lifestyle. In some embodiments, some or all of this information can open on new screens.

A doctor can go to Available Time Screen 600, to see when he has made himself available to patients. Available Time Screen 600 can be viewed as a calendar or a list. In month view, the doctor can scroll through the months or focus on the present day. Days with grey background do not include appointment time slots, while those with blue indicate that the doctor currently has openings on that day for time slot he has made available. The doctor can also center in on the present day to see what appointments, if any, he has scheduled.

The doctor can “add” a new available time slot. When the doctor clicks the add icon, he is taken to Add New Time Screen 620, in which he can identify the date and time for which he wants to add openings to his schedule. The doctor can also setup a schedule with repeating times on certain days by clicking the “Repeat” button. Available time slots can be removed by clicking the trash icon.

Doctors can also access History Screen 30 and search by date. This is important as doctors may wish to review a previous session with a patient to help recall the patient's history, including prior treatment the doctor suggested.

Doctor Setting Screen 440 works very similar to Patient Setting Screen 40. For example, from it the doctor can: “Logout” to close the current session; open Doctor Profile Screen 442 to edit personal information; open Feedback Screen 50 to provide the program operator and/or developers with information about a problem with Application, praise application, or suggest an improvement for application; open the Sync Screen 60; and open Share Screen 70. Although other screens could be used, in this embodiment Feedback Screen 50, Sync Screen 60, and Share Screen 70 are present in both the patient and doctor part of Application and perform the same functions described above.

Doctor Profile Screen 442 is similar to Patient Profile Screen 42 although the information that can be entered is more relevant to a doctor. For example, while both Doctor Profile Screen 442 and Patient Profile Screen 42 allow the user to enter his name, change his password, add photos, and review User Agreement Screen 46 and Privacy Policy Screen 47, Doctor Profile Screen 442 does not contain fields to input patient relevant information, such as medical records, but instead provides doctor relevant fields such as viewing earned income and toggling between being available to receive calls between on and off.

In Application 1, Video Call Screen 200 and Voice Call Screen 210, are used by both the doctor and patient. In other embodiments these screens can differ between the two parts of the program.

Video Call Screen 220 contains the current balance of the patient, a call timer, and buttons to mute the mic, send a photo, open a text chat or drop the call.

Chat Box 220 includes the ability to send and receive photos, type and send messages and return back to the video call screen or voice call screen. In other embodiments, it could have different features.

When the doctor and patient end a video call, voice call, or chat session, Application 1 will send doctor to Payment Adjustment Screen 230. Here the doctor can change the amount he charges the patient. For example, if the call went for less than the scheduled appointment or part of the call was spent exchanging pleasantries, the doctor may give the client a refund. On the other hand, if the call extended beyond the allotted time, the doctor can increase the charge to the client. The doctor can adjust the bill simply by billing for the amount of time services were provided or, in some embodiments, can simply charge a flat rate agreed to by the client during the call.

While particular elements, embodiments and applications of the present invention have been shown and described, it will be understood that the invention is not limited thereto since modifications can be made without departing from the scope of the present disclosure, particularly in light of the foregoing teachings.

What is claimed is:

1. A method of providing a medical service to a patient for a predetermined charge that is adjustable upon completion of delivery of said service, the method comprising:
(a) registering the patient and a medical service provider;
(b) connecting the patient to the service provider via a telecommunications device, thereby enabling the medical service provider to provide a service to the patient;
(c) disconnecting the patient from the service provider upon completion of delivery of said service;
(d) automatically generating a preliminary bill of charges for said predetermined charge; and
(e) providing to the service provider a mechanism for modifying said charges for posting onto a final bill of charges for provision of said service to the patient.

2. The method of claim 1, further comprising allowing the patient to purchase a credit usable to pay said bill.

3. The method of claim 1, further comprising allowing the patient to rate the service provider after said service is provided.

4. The method of claim 1, further comprising allowing the patient to search for the service provider among a list of potential service providers.

5. The method of claim 4, wherein the patient can search among said list of the service providers by at least one of the group of criteria consisting of location of the service provider, insurance accepted by the service provider, and specialty of the service provider.

6. The method of claim 1, wherein said telecommunications device is wireless telephone.

7. The method of claim 1, wherein said telecommunications device is a computer.

8. The method of claim 7, wherein said computer is a tablet.

9. The method of claim 1, wherein the service provider and the patient are connected via a video call.

10. The method of claim 9, wherein the service provider and the patient can open a chat box during said video call.

11. The method of claim 1, wherein the service provider and the patient are connected via a voice call.

12. The method of claim 11, wherein the service provider and the patient can open a chat box during said voice call.

13. The method of claim 12, wherein the service provider and the patient can exchange video images in said chat box.

14. The method of claim 1, wherein the service provider and the patient are connected via a chat room.

15. A computer-readable medium having residing thereon computer-executable instructions for performing a method comprising:
(a) registering a patient and a medical service provider;
(b) connecting the patient to the service provider via a telecommunications device, thereby enabling said medical service provider to provide a service to the patient;
(c) disconnecting the patient from the service provider;
(d) automatically generating a bill of charges for said service; and
(e) providing to the service provider a mechanism for modifying said charges.

16. A method of providing a service to a client for a predetermined charge that is adjustable upon completion of delivery of said service, the method comprising:
(a) registering a client and a professional service provider;
(b) connecting said client to said service provider via a telecommunications device, thereby enabling said service provider to provide a service to the patient;
(c) disconnecting said client from said service provider upon completion of delivery of said service;
(d) automatically generating a preliminary bill of charges for said predetermined charge; and
(e) providing to said service provider a mechanism for modifying said charges for posting onto a final bill of charges for provision of said service to said client.
